(19) United States
(12) Patent Application Publication
(10) Pub. No.: US 2009/0264140 A1
(43) Pub. Date: Oct. 22, 2009

(54) System and Method for Operating a Smart Messaging Network

(76) Inventor: Norial Bain, Washington, DC (US)

Correspondence Address: PCT LAW GROUP, PLLC, 818 CONNECTICUT AVENUE, NW, SUITE 700, WASHINGTON, DC, 20006, US

(21) Appl. No.: 12/425,666

(22) Filed: Apr. 17, 2009

Related U.S. Application Data
(60) Provisional application No. 61/071,193, filed on Apr. 17, 2008.

(51) Int. Cl. H04W 4/12

(52) U.S. Cl. 455/466; 705/14

(57) ABSTRACT

A secure computer system and method is disclosed for providing an online platform whereby text messages are smartly shared with the intent to form social networks. The system allows easy and reliable transmission of mass text messages along with exchange of information to and from a myriad of contributory sources. Among other features, subscribers may choose the time and frequency of received smart messages of particular interest. Among other features, the system allows organizations, particularly educational institutions, to communicate on a widespread and timely basis. Advertising accounts are provided and users may customize the look and feel of smart messages.

### CLAIM OF PRIORITY

This application claims priority from U.S. provisional application No. 61/071,193, filed Apr. 17, 2008, entitled “System and Method for Operating a Smart Messaging Network,” incorporated herein by reference.

### BACKGROUND OF THE INVENTION

1. Field of the Invention

The present invention generally relates to online communications, and more particularly to systems, methods and computer program products for providing a smart messaging network thereby enabling the operation of an online social networking site.

2. Related Art

Even in today's advanced technological climate, during the occasional and unfortunate shooting assaults on school campuses, there is typically no effective system in place that allows students to be immediately notified about the acts of violence being committed on campus. Further, it has been observed that students often-express the desire for services that conveniently provide them with information on topics of their choice. Lastly, social networking sites such as Facebook and MySpace have grown in popularity among young students over the years.

Despite the above-observed facts, a social community has not been formed using any common technology devices. Further, there has not been a service offered capable of customizing text messages similar to the customization of desktops or homepages for certain subscription services.

Given the foregoing, what are needed are systems, methods and computer program products for providing a smart messaging network thereby enabling the operation of an online social networking site.

### BRIEF DESCRIPTION OF THE INVENTION

The present invention meets the above-identified needs by providing systems, methods, and computer program products for operating online social networking sites by providing a smart messaging network.

In an aspect, the present invention provides an online platform whereby text messages are smartly shared with the intent to form social networks, easy and reliable transmission of mass text messages are provided, and information to and from a myriad of contributory sources are efficiently disseminated. As will be appreciated by those skilled in the relevant art(s), “text messages” refers to the “short” (i.e., typically 160 characters or fewer) text messages from mobile telephones using the Short Message Service (SMS).

An advantage of the present invention is that it allows for mass text messages to be sent efficiently and effectively by educational institutions and their faculty/staff.

Another advantage of the present invention is that it provides users the capability of receiving text messages on subjects that are of interest to them at a specified time.

Another advantage of the present invention is that it fosters the creation of social groups that can be easily messaged via mobile telephones or handheld/portable devices and conveniently managed through one or more Web sites.

Yet another advantage of the present invention is that it permits text messages to be customized by users to suit their taste and/or for special occasions.

Yet another advantage of the present invention is that it contributes to the bottom line of a service provider implementing it. That is, because current products/services are not currently packaged in this manner, a site offering such services will attract advertising opportunities that will positively impact the service provider's profit margins.

Yet another advantage of the present invention is that advertisers will be attracted to advertising on a social networking site facilitated by the present invention due to the potential of reaching consumers who are actively requesting to receive text messages containing such information.

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary environment for providing a smart messaging network thereby enabling the operation of an online social networking site according to an aspect of the present invention.

FIG. 2 is a block diagram of an exemplary computer system useful for implementing the present invention.

FIG. 3 is a data flow diagram depicting an aspect of the back end of the tool of the present invention.

### DETAILED DESCRIPTION

The present invention is directed to systems, methods and computer program products for providing a smart messaging network thereby enabling the operation of an online social networking site.

In an aspect, the present invention provides an online platform whereby text messages are smartly shared with the intent to form social networks, easy and reliable transmission of mass text messages are provided, and information to and from a myriad of contributory sources are efficiently disseminated.

In an aspect of the present invention, educational institutions that possess an account with a service provider implementing the present invention can submit a message to be forwarded throughout their campus without having to contact the service provider. Administrators of the institution may possess secure account holder information used to verify legitimate access to their account so they can personally enter a text message to be sent themselves. This not only allows the institution the ease of forwarding messages conveniently, but also ensures the timely dissemination of (safety and other) messages throughout the campus. Consequently, in such an aspect, necessary administration controls may be put into place to assist in ensuring access to such accounts are accessible only by the appropriate faculty/staff.

In another aspect of the present invention, subscribers may receive text messages on topics of interest on the date/time of their choosing and as frequently as they specify. They can also share their service messages with other subscribers/members.

In another aspect of the present invention, subscribers may create, join or leave a “group” (i.e., a collection of subscribers to the service) and extend invitations to allow others to join an existing group.

In another aspect of the present invention, text messages are customizable via text colors, images, background colors, and the text message layout and the like. Further, users may also engage in the forwarding of text messages designed for specific occasions (e.g., birthdays, anniversaries, etc.).

In another aspect of the present invention, a smart message is one of: a mobile instant message (MIM); a Short Message Service (SMS) message; and a Multimedia Messaging Service (MMS) message.

The present invention is now described in more detail herein in terms of the above exemplary contexts. This is for convenience only and is not intended to limit the application of the present invention. In fact, after reading the following description, it will be apparent to those skilled in the relevant art(s) how to implement the following invention in alternative aspects (e.g., non campus-related uses, etc.).

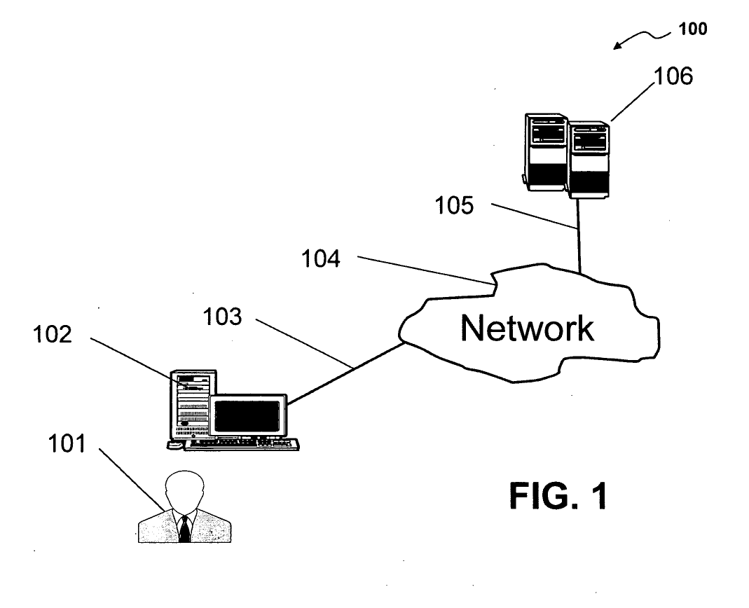

FIG. 1 presents an exemplary environment diagram 100 of various hardware components and other features in accordance with an aspect of the present invention. As shown in FIG. 1, in an aspect of the present invention, data and other information and services for use in the system are, for example, input by a user (i.e., subscriber) 101 via a terminal 102, such as a personal computer (PC), minicomputer, laptop, palmtop, mainframe computer, microcomputer, telephone device, mobile device, personal digital assistant (PDA), or other device having a processor and input and display capability. Terminal 102 is coupled to a server 106, such as a PC, minicomputer, mainframe computer, microcomputer, server computer, or other device having a processor and a repository for data or connection to a repository for maintaining data, via a network 104, such as the global, public Internet, via couplings 103 and 105.

As will be appreciated by those skilled in the relevant art(s) after reading the description herein, in such an aspect, a service provider may allow access, on a free registration, paid subscriber and/or pay-per-use basis, to the tool via one or more World-Wide Web (WWW) sites on the Internet 104. Thus, system 100 is scaleable such that multiple schools, universities, entities, organizations, subscriber groups and the like may utilize it to allow their respective users to create, send, review, receive, and generally interact with one another via smart messages.

As will also be appreciated by those skilled in the relevant art(s), in an aspect, various (login, admin, account, information, resource, logout, payment, registration, communications, etc.) screens would be generated by server 106 in response to input from user 101 over the Internet 104. That is, in such an aspect, server 106 is a typical Web server running a server application at a Web site which sends out Web pages in response to Hypertext Transfer Protocol (HTTP) or Hypertext Transfer Protocol Secured (HTTPS) requests from remote browsers being used by users 101. Thus, server 106 is able to provide a graphical user interface (GUI) to users 101 of system 100 in the form of Web pages. These Web pages sent to the user's PC, laptop, mobile device, PDA or the like device 102, and would result in the GUI being displayed.

As will also be appreciated by those skilled in the relevant art(s) after reading the description herein, alternate aspects of the present invention may include providing the tool for providing a smart messaging network thereby enabling the operation of an online social networking site as a stand-alone system (e.g., installed on one PC) or as an enterprise system wherein all the components of system 100 are connected and communicate via an inter-corporate wide area network (WAN) or local area network (LAN), rather than as a Web service (i.e., application service provider (ASP) model) as shown in FIG. 1. Communications via an inter-corporate wide area network (WAN) allows employees of an organization, or any entity within an organization, to have the capability of communicating in an exclusive, secure environment.

The present invention (i.e., system 100, the methods of facilitating the establishment and operations of a smart messaging network of the present invention, or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

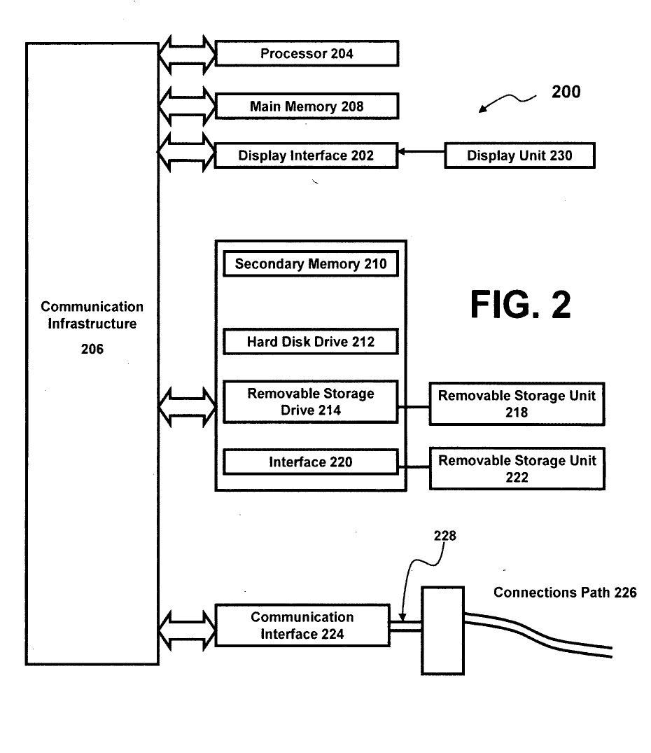

In fact, in one aspect, the invention is directed toward one or more computer systems capable of carrying out the functionality described herein. An example of a computer system 200 is shown in FIG. 2.

The computer system 200 includes one or more processors, such as processor 204. The processor 204 is connected to a communication infrastructure 206 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 214, a hard disk installed in hard disk drive 212, and signals 228. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

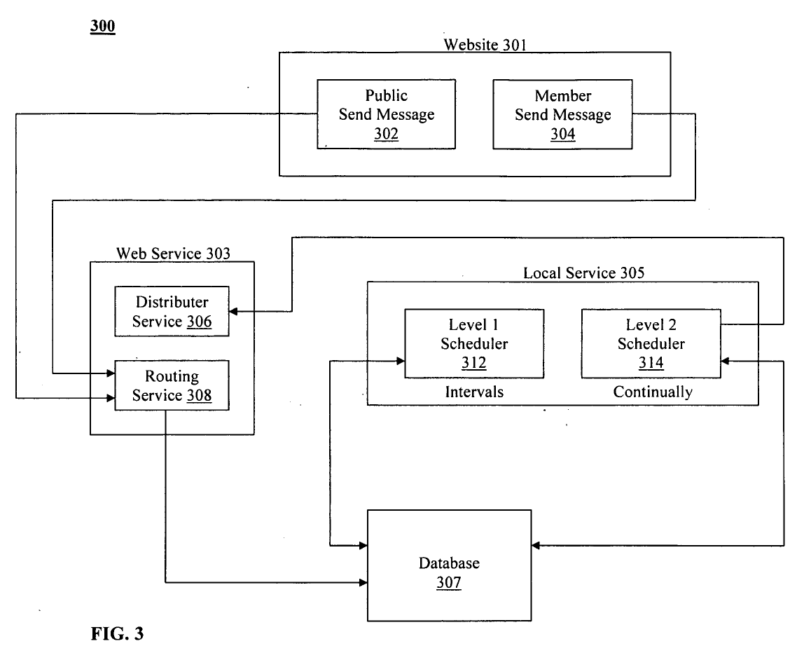

Referring to FIG. 3, a data flow diagram depicting an aspect of the operation and control flow 300 of the tool of the present invention is shown. That is, in an aspect of the present invention, a service provider would utilize the infrastructure shown in FIG. 3 (within the environment shown in FIG. 1) and make available one or more Web sites to subscribers (either free, subscription and/or pay-per-use basis) thereby enabling the operation of an online social networking site via a smart messaging network.

In an aspect of operation and control flow 300, a Web site module 301 (comprised of public sub-module 302 and member sub-module 304) submits the data of a message being sent to a routing service segment 308 of a Web service module 303. This data includes a message which comprises “From,” “To,” “Subject,” “Message” and “When” (i.e., Time) fields. Routing service segment 308 within Web service module 303 stores this information appropriately in a database 307. A Level 1 scheduler segment 312 in a local service module 305 checks database 307 at pre-determined intervals to retrieve the information stored by routing service 308. A Level 2 scheduler segment 314 within local service module 305 checks database 307 continually to retrieve information stored by Level 1 scheduler segment 312. Level 2 scheduler segment 314 within local service module 305 forwards the messages retrieved from the Level 1 scheduler segment 312 in database 307 and transfers to a distributer service 306 within Web service module 303. The messages are then forwarded to the appropriate recipients.

In an aspect of the present invention, users have the capability of submitting text messages to be forwarded on a future date and customizing of the “look and feel” of the text messages.

In another aspect of the present invention, forwarding of service messages is a feature more unique than custom texts because advertisers will have their advertisements forwarded directly to interested consumers. This is a result of subscribers, when signing up for the service/site, specifically stating that they are interested in receiving such text messages. In such an aspect, subscribers can specify the date and/or the frequency with which they would like to receive such text messages without compromising their relationship with advertisers. Thus, subscribers can completely cancel this service at anytime. Fundamentally, subscribers can receive information ranging from the hottest deals to the hippest locations free of charge while advertisers will be more than willing to advertise because they are guaranteed that the people to whom their advertisements are being sent are members of their target audience. As will be appreciated by those skilled in the relevant art(s), as this feature operates, the service provider can garner “advertising intelligence.”

In aspects of the present invention, account holders will be able to perform a myriad of functions on a social networking Web site implementing the present invention, as outlined below.

Groups: Subscribers are not only able to send text messages to individual or multiple recipients, but may also create text-messaging groups with defined characteristics, join existing text-messaging groups, form groups of groups, or leave a text-messaging group. Subscribers seeking to join a group must first receive permission from the creator of the group, which will be automatically sent as a message to the group's creator. The creator of the group can also permit specific or all other members of the group the right to allow their friends/contacts to become a part of the group without the group creator's consent, and set defined characteristics such as unique team or project characteristics including name, description, members, contacts, schedules, notes and reminders. Finally, any member of a group can block the receipt of a text-message from another member at any time.

Smart Services: Subscribers and/or account holders may choose to receive messages regarding specific subjects of interest to them, inclusive of available leases, sports, entertainment, local restaurant specials, specific textbooks, or any other topic of their choice. They can request to receive these messages daily, weekly, bi-weekly, monthly, a specific day of the month, or at any specific time or frequency they choose. Additionally, account holders may select the amount of messages they would like to receive on the subject when it is due to be forwarded to them (i.e., 1, 2, 3, etc.). Subscribers and accountholders may unsubscribe from smart services at anytime.

University/College/School: Administration accounts are available to College/University/School administrators only. Possession of this account by a College/University/School allows campus-wide text messages to be sent to students and/or faculty and/or staff pertaining to campus announcements, alerts, etc. This allows students to provide information (e.g., their mobile telephone number) so that they can receive such text messages from administrators. Once students provide their information to receive administration text messages, they cannot individually unsubscribe from receipt of text messages. However, the University/College/School can unsubscribe student accounts. Access to College/University/School administrators accounts are provided via a secure/private link.

Faculty Accounts: Faculty accounts are available to University/College faculty members (particularly, professors) who can communicate with students about coursework, class announcements, when absent or late days are unavoidable or encountered, etc. Faculty members may create their individual account and instruct students to subscribe to the account so that they can receive text messages with information relating to the course. Students can unsubscribe from faculty accounts at anytime and faculty can cancel their faculty account at their convenience (e.g., at the end of the current semester).

Custom Texts: These types of text messages may be sent on certain occasions (e.g., birthdays, Valentine's Day, Christmas, New Year's, Easter, Thanksgiving, Memorial Day, etc.) with customized backgrounds including, but not limited to, colors, images, text and videos. Therefore, images and video can be uploaded and sent as a text-message or part of a text-message.

Upload Text to Blog: Allows account holders to send text messages as a post to their blog sites, which can include images and/or video.

Advertiser Accounts: Advertisers seeking to advertise may connect to the Web site via a secure/private link. They can then submit their advertisement and other necessary details for review by the service provider and eventual dissemination throughout the site's community as a smart service message. Consequently, advertisers can create and cancel their account(s) as well as upload their logo(s) for use in service messages sent to subscribers.

While various aspects of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary aspects.

In addition, it should be understood that the figures in the attachments, which highlight the structure, methodology, functionality and advantages of the present invention, are presented for example purposes only. The present invention is sufficiently flexible and configurable, such that it may be deployed and implemented in ways other than that shown in the accompanying figures. Thus, while only certain embodiments of the invention have been specifically described herein, it will be apparent that numerous modifications may be made thereto without departing from the spirit and scope of the invention, as defined in the attached claims.

1. A computer-implemented method for a service provider to facilitate facilitating the operation of a smart messaging network, comprising the steps of:
receiving, at a website, data from a plurality of recipients in order to allow each of said plurality of recipients to subscribe to a smart messaging service provided by an account holder established by the said service provider;
receiving, at said website, a smart message from said account holder;
storing said smart message in a database;
receiving data from said account holder indicative of a subset of said plurality of subscribers selected to receive said smart message;
retrieving, by a distributer service, said smart message from said database; and
forwarding, by said distributer service, said smart message to said subset of said plurality of subscribers.

2. The method of claim 1, wherein said smart message is one of: a mobile instant message (MIM); a Short Message Service (SMS) message; and an a Multimedia Messaging Service (MMS) message.

3. The method of claim 1, further comprising the steps of:
receiving, from an advertiser, data associated with at least one advertisement; and
inserting said advertiser data into said smart message before forwarding said smart message to said subset of said plurality of subscribers.

4. A computer program product comprising a computer usable medium having control logic stored therein for causing a computer to allow a service provider to facilitate the operations of a smart messaging network, said control logic comprising:
first computer readable program code means for causing the computer to receive data from a plurality of recipients in order to allow each of said plurality of recipients to subscribe to a smart messaging service provided by an account holder;
second computer readable program code means for causing the computer to receive a smart message from said account holder;
third computer readable program code means for causing the computer to store said smart message;
fourth computer readable program code means for causing the computer to receive data from said account holder indicative of a subset of said plurality of subscribers selected to receive said smart message;
fifth computer readable program code means for causing the computer to retrieve said smart message from said database; and
sixth computer readable program code means for causing the computer to forward said smart message to said subset of said plurality of subscribers.

5. The computer program product of claim 4, further comprising:
seventh computer readable program code means for causing the computer to receive, from an advertiser, data associated with at least one advertisement; and
eighth computer readable program code means for causing the computer to insert said data into said smart message before forwarding said smart message to said subset of said plurality of subscribers.

6. The computer program product of claim 4, further comprising:
seventh computer readable program code means for causing the computer to post said smart message to at least one blog website.

7. The computer program product of claim 4, further comprising:
seventh computer readable program code means for causing the computer to allow said account holder to customize said smart message by choosing at least one of: a foreground color; an image; a background color; and a layout; for said smart message.

8. The computer program product of claim 4, further comprising:
seventh computer readable program code means for causing the computer to allow said subscriber to choose at least one of: a time and a frequency; to receive said smart message.

9. The method of claim 1, further comprising the step of posting said smart message to at least one blog website.

10. The method of claim 1, further comprising the step of:
allowing said account holder to customize said smart message by choosing at least one of: a foreground color; an image; a background color; and a layout; for said smart message.

11. The method of claim 1, further comprising the step of:
allowing said subscriber to choose at least one of: a time and a frequency; to receive said smart message.

12. A secure computer system for allowing a service provider to provide a smart messaging network comprising:
a database, operable to:
store a smart message; and
store data associated with a plurality of recipients;
a website, operable to:
receive data from said plurality of recipients in order to allow each of said plurality of recipients to subscribe to a smart messaging service provided by an account holder established by the service provider;
receive said smart message from said account holder; and
receive data from said account holder indicative of a subset of said plurality of subscribers selected to receive said smart message;
a web service, operable to:
retrieve said smart message from said database; and forward said smart message to said subset of said plurality of subscribers; and
a local service, operable to schedule said forwarding of said smart message to said subset of said plurality of subscribers.

13. The system of claim 12, wherein said smart message is one of: a mobile instant message (MIM); a Short Message Service (SMS) message; and an Multimedia Messaging Service (MMS) message.

14. The system of claim 12, wherein said website is further operable to:
receive, from an advertiser, data associated with at least one advertisement.

15. The system of claim 12, wherein said web service is further operable to:
insert said advertiser data into said smart message before forwarding said smart message to said subset of said plurality of subscribers.

16. The system of claim 12, wherein said web service is further operable to post said smart message to at least one blog website.

17. The system of claim 12, wherein said website is further operable to allow said account holder to customize said smart message by choosing at least one of: a foreground color; an image; a background color; and a layout; for said smart message.

18. The system of claim 12, wherein said website is further operable to allow said subscriber to choose at least one of: a time and a frequency; to receive said smart message.
